(19) United States
(12) Patent Application Publication
(10) Pub. No.: US 2013/0158759 A1
(43) Pub. Date: Jun. 20, 2013

(54) ELECTRIC PERSONAL MOVING APPARATUS

(71) Applicants: Young Chul OH, Hwaseong (KR); Byung Yong YOU, Hwaseong (KR); Hui Sung LEE, Hwaseong (KR); Sung Won YOON, Yongin (KR); Hyun Jae YOO, Seoul (KR)

(72) Inventors: Young Chul OH, Hwaseong (KR); Byung Yong YOU, Hwaseong (KR); Hui Sung LEE, Hwaseong (KR); Sung Won YOON, Yongin (KR); Hyun Jae YOO, Seoul (KR)

(73) Assignee: Hyundai Motor Company, Seoul (KR)

(21) Appl. No.: 13/472,568

(22) Filed: May 16, 2012

(30) Foreign Application Priority Data
Dec. 14, 2011 (KR) 10-2011-0134918

(51) Int. Cl. B60L 15/00

(52) U.S. Cl. 701/22

(57) ABSTRACT

An electric personal moving apparatus is provided. The electric personal moving apparatus includes a pair of modules detachable/attachable to shoes or a user's feet, wherein each module moves by propulsion from a motor and can be variously controlled by short range wireless communication.

### CROSS-REFERENCE TO RELATED APPLICATION

This application is based on and claims priority from Korean Patent Application No. 10-2011-0134918, filed on Dec. 14, 2011 in the Korean Intellectual Property Office, the disclosure of which is incorporated herein in its entirety by reference.

### BACKGROUND OF THE INVENTION

1. Field of the Invention

The present invention relates to an electronic personal moving apparatus, and more particularly, to an electronic personal moving apparatus including a pair of modules detachable/attachable to shoes, wherein each module moves via propulsion of a motor and can be variously controlled by short range wireless communication.

2. Description of the Prior Art

Generally, an inline skate has a structure in which three to five wheels are mounted in a row on a straight frame and shoes are attached over the frames, accordingly. Typically, inline skates are mainly used for leisure. However, some individuals use them as a means of aerobic exercise as well. Inline skating can improve balance, and strengthen muscles, and as a result, has become quite a popular past time for many individuals.

In addition, inline skates are also used by a growing number of individuals to move through congested urban areas as a mode of transportation. Since, inline skates can be carried in an individual's bag and can be easily worn anytime, anywhere as needed unlike a bicycle, they are a faster and more convenient means of travel than a bicycle or walking which has aided in their growing popularity.

However, tone noted limitation of inline skates is a persons own physically competence. Thus, some individuals are not able to effectively operate inline skates due to a lack of balance or lack of sufficient motor skills to effect proficient operation of the inline skates in a way that is safe and aerobically beneficial.

### SUMMARY OF THE INVENTION

Accordingly, the present invention has been made to solve the above-mentioned problems occurring in the prior art while advantages achieved by the prior art are maintained intact.

The illustrative embodiment of the present invention provides an electric personal moving apparatus including a pair of modules detachable/attachable to shoes, wherein each module moves via a driving force or propulsion of a motor and can be variously controlled by short range wireless communication.

In one aspect of the present invention, an electric personal moving apparatus is provided that includes: a main module that is configured to sense pressure generated by a left foot of a user and determine and provide control commands corresponding to the sensed pressure. In response, the main module is operated according to a priority of the control commands provided based upon the pressure generated by the left foot generated by the user. These control commands are then transmitted to a slave module, which in return provides the main module with speed information and pressure information of the slave module. The main module is then operated based on the speed information and pressure information from the slave module and the pressure information generated by the user's left foot, the main modules.

The slave module is operated according to the priority of the control commands from the main module, and senses pressure generated by a right foot of the user and determines control commands corresponding to the sensed pressure. The slave module is then operated in response to the control commands from the slave module and the main module.

In another aspect of the present invention, there is provided an electric personal moving apparatus, including: a short range communication terminal that is configured to transmit control commands through short range wireless communication; a main module that is configured to receive speed information from a slave module and is operated based on the control commands from the short range communication terminal; and a slave module that that is configured to transmit the speed information to the main module and is operated based on the control commands from the short range communication terminal.

### BRIEF DESCRIPTION OF THE DRAWINGS

The above and other objects, features and advantages of the present invention will be more apparent from the following detailed description taken in conjunction with the accompanying drawings, in which:

FIG. 1 is a configuration diagram of an electric personal moving apparatus according to an exemplary embodiment of the present invention;

FIG. 2 is a detailed configuration diagram of a pressure sensor of a main module according to an exemplary embodiment of the present invention;

FIG. 3 is an exemplified diagram of the electric personal moving apparatus according to an exemplary embodiment of the present invention;

FIG. 4 is a detailed configuration diagram of a pressure sensor of a slave module according to the exemplary embodiment of the present invention; and

FIG. 5 is a configuration diagram of an electric personal moving apparatus according to another exemplary embodiment of the present invention.

### DETAILED DESCRIPTION OF THE PREFERRED EMBODIMENTS

Hereinafter, exemplary embodiments of the present invention will be described in detail with reference to the accompanying drawings.

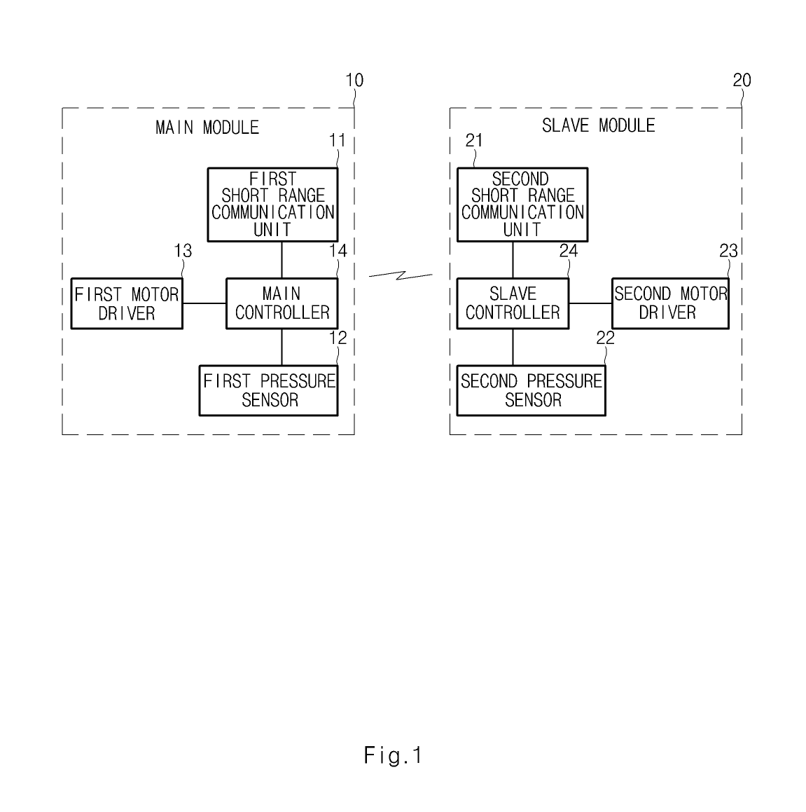

FIG. 1 is a configuration diagram of an electric personal moving apparatus according to an exemplary embodiment of the present invention. As shown in FIG. 1, an electric personal moving apparatus according to an exemplary embodiment of the present invention includes a main module 10 and a slave module 20. First, the main module 10, which is a module mounted on a left shoe, includes a first short range communication unit 11, a first pressure sensor 12, a first motor driver 13, and a main controller 14. Further, the main module 10 may include a first battery (not shown), a first motor (not shown), two wheels, and a power switch (not shown).

Describing each component, the first short range communication unit 11 communicates with a second short range communication unit 21 of the slave module 20. In this configuration, the short range communication unit 11 may communicate with the second short range communication unit 21 by any one of infrared communication, Bluetooth, Zigbee, etc. The first short range communication unit 11 periodically receives speed information and pressure information of the slave module 20 from the second short range communication unit 21. Further, the first short range communication unit 11 transmits an acceleration command or a deceleration command to the second short range communication unit 21 according to the control of the main controller 14.

The first pressure sensor 12 senses pressure that is generated by a user's foot that exceeds threshold value. That is, in order to control the speed and direction of the main module 10, the user applies force to a specific portion of his/her feet to generate a certain amount of pressure that exceeds a threshold value or more, which is sensed by the first pressure sensor 12.

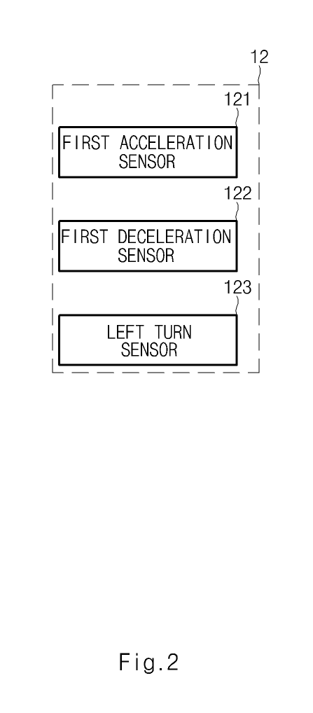

As shown in FIG. 2, the first pressure sensor 12 includes a first acceleration sensor 121, a first deceleration sensor 122, and a left turn sensor 123. The first acceleration sensor 121 is provided, for example, at a position corresponding to a portion of a user's big toe to sense when the user applies pressure of a first threshold value or more in a location near his/her big toe. The first deceleration sensor 122 is provided, for example, at a position corresponding to a portion of a user's heel to sense when the user applies pressure of a second threshold value or more to a location around his/her heel. The left turn sensor 123 is provided, for example, at a position corresponding to a portion of a user's little toe to sense when the user applies pressure of a third threshold value or to a location around his/her little toe.

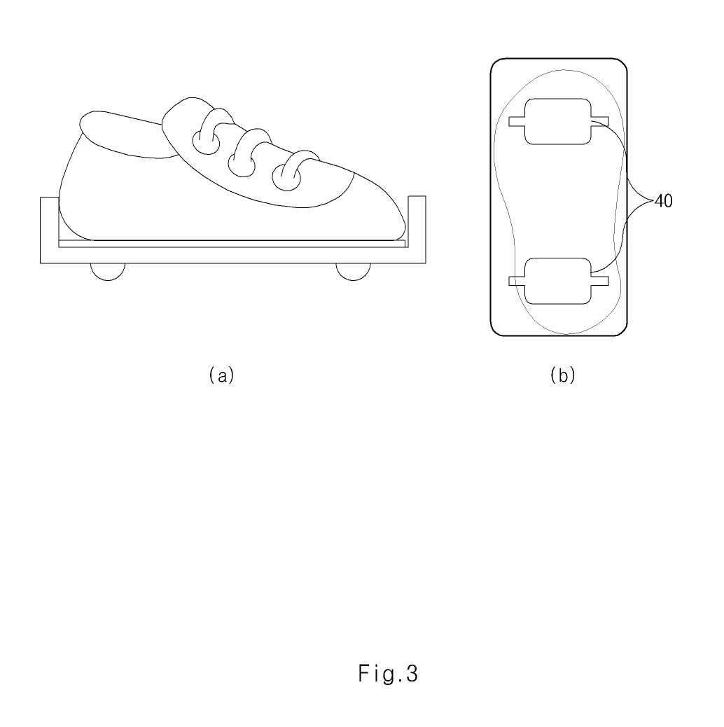

The first motor driver 13 drives a first motor according to the control of the main controller 14 to implement acceleration or deceleration. In this case, the first motor operably turns two wheels. The two wheels are arranged in a single file as shown in FIG. 3. That is, the first motor driver 13 increases a rotating speed of the first motor according to an acceleration signal from the main controller 14 to implement the acceleration of the wheels 40.

In addition, the first motor driver 13 decreases the rotating speed of the first motor according to a deceleration signal from the main controller 14 to perform deceleration. Further, the first motor driver 13 sustains the rotating speed of the first motor according to a maintain signal from the main controller 14 to maintain a current speed.

The main controller 14 controls electric personal moving apparatus based on various types of commands from a user sensed by the first pressure sensor 12, rather than based on analysis results of pressure information received from the slave module 20. That is, the main controller 14 processes the sensed acceleration, deceleration, and right turns according to the analysis results of the pressure information as follows, in the state in which the first pressure sensor 12 does not sense any command from the user.

When the main controller 14 senses the acceleration or the deceleration by the pressure information from the slave module 20, the main controller 14 controls the first motor driver 13 to maintain a constant speed. Further, when the main controller 14 senses the right turn by the pressure information from the slave module 20, the main controller 14 controls the first motor driver 13 to accelerate the speed of the main module 10 by a predetermined value based on the current speed of the slave module 20.

Meanwhile, when the main controller 14 senses the acceleration command from the user by the first pressure sensor 12, the main controller 14 controls the first motor driver 13 to implement the acceleration in response to the acceleration command. Simultaneously, the acceleration command is transmitted to the slave module 20 through the first short range communication unit 11. In this case, the slave controller 24 controls the second motor driver 23 so as to implement the acceleration in response to the received acceleration command.

Further, when the main controller 14 senses the deceleration command from the user by the first pressure sensor 12, the main controller 14 controls the first motor driver 13 to implement deceleration in response to the deceleration command. Simultaneously, the deceleration command is transmitted to the slave module 20 through the first short range communication unit 11. In this case, the slave controller 24 controls the second motor driver 23 to implement the deceleration in response to the received deceleration command.

Further, when the main controller 14 senses the left turn command from the user by the first pressure sensor 12, the main controller 14 controls the first motor driver 13 to decelerate the speed of the main module 10 by a predetermined value based on the current speed of the slave module 20. Alternatively, when the first pressure sensor 12 does not sense the pressure above a threshold value during the movement, the main controller 14 controls the first motor driver 13 so that the main module 10 maintains the current speed.

Additionally, the main controller 14 transmits a turn-on signal to the slave module 20 when the power switch is turned-on to operate the slave module.

Next, the slave module 20, which is a module mounted on a right shoe, includes the second short range communication unit 21, the second pressure sensor 22, the second motor driver 23, and the slave controller 24. The slave module 20 further includes a second battery (not shown), a second motor (not shown), and two wheels (not shown).

Describing each component, the second short range communication unit 21 communicates with the first short range communication unit 21 of the main module 10. In this configuration, the short range communication unit 11 may communicate with the second short range communication unit 21 by any one of infrared communication, Bluetooth, Zigbee, etc. That is, the second short range communication unit 21 periodically transmits the speed information and pressure information of the slave module 20 to the first short range communication unit 11. In addition, the second short range communication unit 21 receives the acceleration command or the deceleration command from the first short range communication unit 11.

The second pressure sensor 22 senses the pressure that is generated by a user's foot that again exceeds a threshold value. That is, in order to control the speed and direction of the slave module 20, the user applies force to a specific portion of his/her right foot to generate at least a threshold pressure, which is sensed by the second pressure sensor 22.

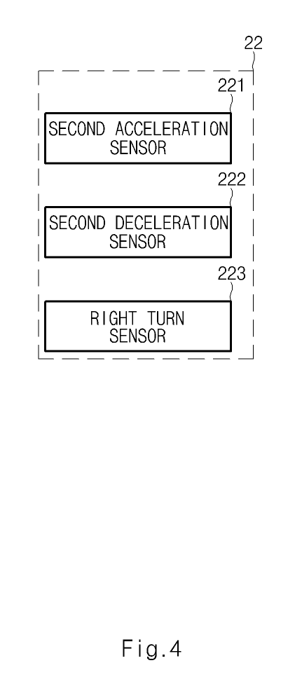

As shown in FIG. 4, the second pressure sensor 22 includes a second acceleration sensor 221, a second deceleration sensor 222, and a right turn sensor 223. The second acceleration sensor 221 is, for example, provided at a position corresponding to a portion of a user's big toe to sense when the user applies pressure of a first threshold value or more to a location near his/her big toe. The second deceleration sensor 222 is provided, for example, at a position corresponding to a portion of a user's heel to sense when the user applies pressure of a second threshold value or more a location near his/her heel. The right turn sensor 223 is provided, for example, at a position corresponding to a portion of a user's little toe to sense when the user applies the pressure of the third threshold value or more o a location near his/her little toe.

The second motor driver 23 drives a second motor (not shown) according to the control of the slave controller 24 to implement acceleration or deceleration to the slave module. In this case, the second motor rotates two wheels. The two wheels 40 are arranged in a single file as shown in FIG. 3. The second motor driver 23 increases the rotation speed of the second motor according to an acceleration signal from the slave controller 24 to perform the acceleration. In addition, the second motor driver 23 decreases the rotation speed of the second motor according to a deceleration signal from the slave controller 24 to perform the deceleration. Further, the second motor driver 23 sustains the rotation speed of the second motor according to a maintain signal from the slave controller 24 to maintain a current speed.

The slave controller 24 controls the slave module 20 based on the command received from the main module 20, rather than based on the command from the user sensed by the second pressure sensor 22. That is, when the slave controller 24 receives the acceleration command from the main module 10, the slave controller 24 controls the second motor driver 23 so as to implement acceleration in response to an acceleration command. Further, when the slave controller 24 receives a deceleration command from the main module 10, the slave controller 24 controls the second motor driver 23 so as to implement deceleration in response to the deceleration command.

However, when the slave controller 24 does not receive any command from the main module 20, and the second pressure sensor 22 senses the acceleration command from the user, the slave controller 24 controls the second motor driver 23 so as to implement acceleration in response to an acceleration command from the slave controller. In this case, the speed information is transmitted to the main module 20, accordingly. Thus, the commands that are received from the main controller are primary commands and those command received at or by the slave module are secondary commands.

In addition, when the slave controller 24 does not receive any command from the main module 20, and the second pressure sensor 22 senses the deceleration command from the user, the slave controller 14 controls the second motor driver 23 so as to implement the deceleration in response to the deceleration command. In this case, the speed information is transmitted to the main module 20 as well so that the main module may operate accordingly.

Even further, when slave controller 24 does not receive any command from the main module 20, and the second pressure sensor 22 senses a right turn command from the user, the slave controller transmits the sensed right turn command to the main module 10 and the wheel on both the main module and the slave module are operated accordingly. [NOTE: In this case, does the slave module simultaneously control the wheels to turn in the rightward direction and transmit.

As a result, the slave controller 24 serves to control the slave module 20, but the main controller 14 serves to control the main module 10 and the slave module 20. That is, the main controller 14 maintains the speed of the main module 10 and the speed of the slave module 20 so that they are operating at a consistent speed. Then, when the control command from the user is generated, the main controller 14 generally controls the main module 10 and the slave module 20.

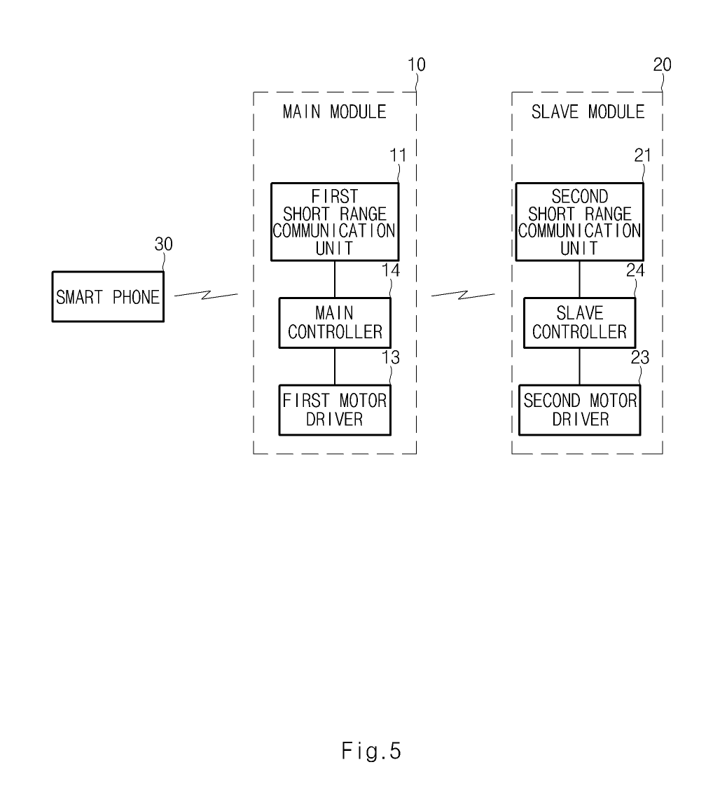

FIG. 5 is a configuration diagram of an electric personal moving apparatus according to another exemplary embodiment of the present invention. As shown in FIG. 5, components of the electric personal moving apparatus according to another exemplary embodiment of the present invention is the same as the electric personal moving apparatus according to the exemplary embodiment of the present invention as shown in FIG. 1. In addition, functions of components thereof are also the same.

However, the exemplary embodiment of FIG. 5 includes a smart phone 30 (or controller) that can implement short range communication without including the first pressure sensor 12 of the main module 10 and the second pressure sensor 22 of the slave module 20 that are the components of the exemplary embodiment of the present, thereby controlling the speed and direction of the electric personal moving apparatus via the smart phone. That is, the user executes control applications in the smart phone 30 to control the speed and direction of the electric personal moving apparatus. In this case, the main module 10 periodically receives the speed information from the slave module 20.

In more detail, when the user issues the acceleration command through the smart phone 30, the acceleration command is transmitted to the main module 10 and the slave module 20 through the short range wireless communication. In this case, the main controller 14 of the main module 10 controls the first motor driver 13 so as to implement the acceleration in response to the acceleration command and the slave controller 24 of the slave module 20 controls the second motor driver 23 so as to implement the acceleration in response to the acceleration command.

Further, when the user issues the deceleration command through the smart phone 30, the deceleration command is transmitted to the main module 10 and the slave module 20 through the short range wireless communication. In this case, the main controller 14 of the main module 10 controls the first motor driver 13 so as to implement the deceleration in response to the deceleration command and the slave controller 24 of the slave module 20 controls the second motor driver 23 so as to implement the deceleration in response to the deceleration command.

Further, when the user issues the left turn command through the smart phone 30, the left turn command is transmitted to the main module 10 through the short range wireless communication. In this case, the main controller 14 of the main module 10 controls the first motor driver 13 so as to decelerate the speed of the main module 10 by a predetermined value based on the current speed of the slave module 20.

Further, when the user issues the right turn command through the smart phone 30, the right turn command is transmitted to the main module 10 through the short range wireless communication. In this case, the main controller 14 of the main module 10 controls the first motor driver 13 so as to accelerate the speed of the main module 10 by a predetermined value based on the current speed of the slave module 20.

Meanwhile, as the exemplary embodiment of the present invention, when the user issues the acceleration command or the deceleration command through the smart phone 30, the command is transmitted to the main module 10 through the short range wireless communication and the main module 10 may transmit the acceleration command or the deceleration command received from the smart phone 30 to the slave module 20. In this case, the main module 10 periodically receives the speed information from the slave module 20 through the short range wireless communication.

Furthermore, the control logic of the present invention may be embodied as non-transitory computer readable media on a computer readable medium containing executable program instructions executed by a processor, controller or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The exemplary embodiments of the present invention includes a pair of modules detachable/attachable to shoes, wherein each module can is propelled via an individually mounted motor and can be variously controlled via a short range wireless communication, such that a user can more easily and simply use the inline skates even if they lack certain motor skills.

Although preferred embodiments of the present invention have been described for illustrative purposes, those skilled in the art will appreciate that various modifications, additions and substitutions are possible, without departing from the scope and spirit of the invention as disclosed in the accompanying claims.

What is claimed is:

1. An electric personal moving apparatus, comprising:
a main module configured to:
sense pressure generated by a left foot of a user and in response to sensing pressure, determine and provide control commands corresponding to the sensed pressure,
in response to the commands provided by a main controller, operate the main module based on a control command priority and;
transmit the control commands to a slave module, wherein the main controller provides and operates the main module based on speed information and pressure information received from the slave module; and
the slave module configured to
transmit the speed information and the pressure information to the main controller,
operate, by a slave controller, the slave module according to the control command priority received from the main controller,
sense pressure generated by a right foot of the user and in response determine and provide control commands corresponding to the pressure generated by a right foot of the user, wherein the slave module is operated based on commands provided by the slave controller and the control command priority received from the main module.

2. The electric personal moving apparatus according to claim 1, wherein the main module includes:
a first short range communication unit configured to receive the speed information and the pressure information from the slave module and transmits the control commands to the slave module;
a first pressure sensor configured to sense whether a pressure applied by a user's left foot exceeds a predetermined threshold pressure value or more;
a main controller configured to control a first motor driver based on the speed information and the pressure information received in the first short range communication unit and control the first motor driver according to the control command priority corresponding to the pressure sensed by the first pressure sensor; and
the first motor driver configured to propel a first motor according to the control of the main controller.

3. The electric personal moving apparatus according to claim 2, wherein the first pressure sensor includes:
a first acceleration sensor that is provided at a position corresponding to a location near a user's big toe to sense pressure of a first threshold value or more applied to the location near the user's big toe by the user;
a first deceleration sensor that is provided at a position corresponding to a portion of a user's heel to sense pressure of a second threshold value or more applied to the location near the user's heel by the user; and
a left turn sensor that is provided at a position corresponding to a location near a user's little toe to sense pressure of a third threshold value or more applied to the location near the user's little toe by the user.

4. The electric personal moving apparatus according to claim 2, wherein the control command corresponding to the pressure is any one of an acceleration command, a deceleration command, and a left turn command.

5. The electric personal moving apparatus according to claim 4, wherein when the control command corresponding to the pressure is the left turn command, the main controller controls the first motor driver to decelerate a speed of the main module by a predetermined value based on a current speed of the slave module.

6. The electric personal moving apparatus according to claim 2, wherein when the pressure information received in the first short range communication unit is a right turn command, the main controller controls the first motor driver to accelerate a speed of the main module by a predetermined value based on a current speed of the slave module.

7. The electric personal moving apparatus according to claim 1, wherein the first slave module includes:
a second short range communication unit configured to transmit the speed information and the pressure information to the main module and receives the control commands from the main module;
a second pressure sensor configured to sense whether a pressure applied by a user's right foot exceeds a predetermined threshold value or more;
a slave controller configured to analyze the pressure sensed by the second pressure sensor to determine provide the control commands of the user and then, control a second motor driver in response to the determined control command and control the second motor driver according to the control command priority received from the main module; and
the second motor driver configured to control propulsion of a second motor according to the control of the slave controller.

8. The electric personal moving apparatus according to claim 7, wherein the second pressure sensor includes:
a second acceleration sensor that is provided at a position corresponding to a location near a user's big toe to sense pressure of a first threshold value or more applied to the location near the user's big toe by the user;
a second deceleration sensor that is provided at a position corresponding to a location near a user's heel to sense pressure of a second threshold value or more applied to the location near the user's heel by the user; and
a right turn sensor that is provided at a position corresponding to a location near a user's little toe to sense pressure of a third threshold value or more applied to the location near the user's little toe by the user.

9. The electric personal moving apparatus according to claim 7, wherein the control command of the user is any one of an acceleration command, a deceleration command, and a right turn command.

10. An electric personal moving apparatus, comprising:
a short range communication terminal configured to transmit control commands through short range wireless communication;
a main module configured to receive a user's left foot and configured to receive speed information from a slave module and operated based on the control commands from the short range communication terminal; and
a slave module configured to receive a user's right foot and configured to transmit the speed information to the main module and operated based on the control commands from the short range communication terminal.

11. The electric personal moving apparatus according to claim 10, wherein the control command is any one of an acceleration command, a deceleration command, a left turn command, and a right turn command.

12. The electric personal moving apparatus according to claim 11, wherein when the control command is the left turn command, the main module decelerates a speed of the main module by a predetermined value based on a current speed of the slave module.

13. The electric personal moving apparatus according to claim 11, wherein when the control command is the right turn command, the main module accelerates a speed of the main module by a predetermined value based on a current speed of the slave module.

14. An electric personal moving apparatus, comprising:
a main module configured to receive a user's left foot including:
a first communication unit configured to communicate with a second communication unit,
a first drive motor driver mounted on the main module configured to control propulsion two or more wheels rotatably installed on the main module, and
a main controller configured to control the first drive motor driver to accelerate, decelerate and turn the wheels on at least the main module based on commands input by a user;
a slave module configured to receive a user's right foot including
a second communication unit configured to communicate with a second communication unit′
a second drive motor driver, mounted on the slave module, configured to control propulsion of two or more wheels rotatably installed on the slave module, and
a slave controller configured to control the second drive motor driver to accelerate, decelerate and turn the wheel on the slave module based on commands input by a user.

15. The electronic personal moving apparatus of claim 14, wherein commands provided by the slave controller are secondary to command received from the main controller.
